(19) United States
(12) Patent Application Publication
(10) Pub. No.: US 2025/0119288 A1
(43) Pub. Date: Apr. 10, 2025

(54) SECURE DATA STORAGE USING DATA INTEGRITY VERIFICATION FOR AUTONOMOUS SYSTEMS AND APPLICATIONS

(71) Applicant: NVIDIA CORPORATION, Santa Clara, CA (US)

(72) Inventors: Stephen Aaron WOLFE, San Jose, CA (US); Mihir JOSHI, Santa Clara, CA (US); Tao YE, Santa Clara, CA (US); Mustafa Yigit BILGEN, Brookline, MA (US); Hyung Taek RYOO, Pleasanton, CA (US); Arun GONA, Bothell, WA (US); Santosh KATVATE, Pune (IN)

(21) Appl. No.: 18/424,555

(22) Filed: Jan. 26, 2024

(30) Foreign Application Priority Data
Oct. 4, 2023 (IN) 202341066435

(51) Int. Cl. H04L 9/32; G06F 21/60

(52) U.S. Cl. CPC H04L 9/3213; G06F 21/602; H04L 9/3242

(57) ABSTRACT

In various examples, a technique for verifying data integrity is disclosed that includes receiving a request to access a data block of a plurality of data blocks stored in a non-secure memory. The technique further includes identifying, in a secure memory, an authentication token associated with the data block. The technique also includes generating an updated authentication token based on the data block. The technique further includes determining whether the updated authentication token corresponds to the identified authentication token stored in the secure memory. The technique still further includes in response to determining that the updated authentication token corresponds to the identified authentication token stored in the secure memory, performing one or more operations using the data block.

### CROSS-REFERENCE TO RELATED APPLICATIONS

This application claims the benefit of the India Provisional Application No. 202341066435, filed on Oct. 4, 2023, which is hereby incorporated by reference in its entirety.

### BACKGROUND

An autonomous or semi-autonomous vehicle is typically equipped with cameras, depth sensors, and/or other sensors that are used to detect and understand the environment around the vehicle. Data collected by the sensors is used by downstream components to make important decisions related to stopping the vehicle, starting the vehicle, controlling the speed of the vehicle, determining a path to be taken by the vehicle, disengaging an autonomous driving mode on the vehicle, and/or otherwise operating the vehicle.

Consequently, detecting unauthorized changes in sensor data-which can be caused by unauthorized tampering with sensors or unauthorized operations performed by downstream components-is critical to reliable autonomous or semi-autonomous operation and navigation. For example, modification of camera images by unauthorized operations may cause the downstream components to incorrectly identify objects in the environment around the vehicle, and result in incorrect or improper driving decisions.

Secure computing systems provide data confidentiality, which protects data from being accessed by unauthorized entities, and data integrity, which involves detecting unauthorized or unexpected modification of data. Applications such as automotive systems have requirements for secure computations that can be performed under strict time constraints with limited computational resources. For example, in an automotive system, a security sub-system is involved in protecting core vehicle operations by verifying the integrity of real-time sensor data and vehicle actuation commands. For example, the automotive system can receive incorrect data from a vehicle camera as a result of unauthorized program code tampering with the camera output data. Such tampering can be difficult to detect using techniques such as parity bits or checksums, which are efficient but can be bypassed by unauthorized program code.

One approach that has been implemented to provide tamper-resistant data integrity involves encrypting data at a sensor using a cryptographic key associated with the sensor, encrypting the key, and storing the encrypted keys in a secure memory device. The secure memory device is a flash memory that implements a security protocol to prevent tampering with the data stored in the memory device.

The use of secure memory devices in automotive systems, however, leads to performance losses. In particular, in the automotive sensor data example, an engine control unit accesses the sensor data by retrieving the secret cryptographic key associated with the sensor from the secure memory device and using the retrieved key to decrypt the sensor data. The secure memory device processes memory read and write requests at substantially lower rates relative to a non-secure memory device. The relatively slower performance of the secure memory device are due, in part, to the encryption and decryption operations being performed by the limited processor resources available on the secure memory device. Further, the communication overhead resulting from the use of a packet-based communication serial bus protocol by the secure memory device also degrades performance. In contrast, non-secure memory devices use a more efficient streaming communication protocol. In applications that encrypt a substantial amount of data, such as the automotive system that uses a different key for each sensor, the slower performance of the secure memory device causes a substantial delay in operation that is noticeable by users. For example, the sensor keys are read from the secure memory device each time the automotive system is rebooted, thereby causing a substantial time delay before the automotive system is ready for operation.

Another approach to provide tamper-resistant data integrity involves storing the data in a read-only secure memory, which can be more efficient than a secure memory that provides read and write access. However, applications such as automotive systems update individual keys at various times during operation, e.g., when keys expire or are modified. Read-only secure memory is thus not a viable solution for such applications.

Still another approach involves storing the data in a non-secure memory and storing a hash value that is determined based on the data in a secure memory device. The hash value can be calculated using SHA-1 (Secure Hash Algorithm 1), for example. The hash value can subsequently be used to determine whether the data in the non-secure memory has changed, since any change in the data causes a subsequent hash value computation based on the data in the non-secure memory to generate a different hash value. If the subsequent hash value is different from the previously calculated hash value stored in the secure memory device, then the data has been modified, potentially as a result of tampering. The secure memory device protects the hash value against tampering.

However, when an application updates an item of data during operation, such as a stored key, the entire memory page on which the item is stored has to be re-written because flash memory can only be modified at the page level. In operation, the page is read from the flash memory, the page is updated with the new data item, a new hash value is calculated for the entire page, and the entire page is re-written the flash memory. The calculation of the hash value for the entire page and the write operation are both relatively slow operations, and re-writing the page causes wear on the flash memory device. Thus, using secure memory to store a hash value for a substantial amount of data, such as a set of keys, that is updated over time is not feasible.

As such, a need exists for more effective techniques for efficiently verifying data integrity by securely detecting changes in data in autonomous or semi-autonomous systems.

### SUMMARY

Embodiments of the present disclosure relate to secure detection of changes in data. The techniques described herein include receiving a request to access a data block in a plurality of data blocks stored in a non-secure memory. The techniques further include identifying, in a secure memory, an authentication token associated with the data block. The techniques also include generating an updated authentication token based on the data block. The techniques further include determining whether the updated authentication token corresponds to the identified authentication token stored in the secure memory. The techniques still further include, in response to determining that the updated authentication token corresponds to the identified authentication token stored in the secure memory, performing one or more operations using the data block.

One technical advantage of the disclosed techniques relative to the prior art is the ability to detect modification of data stored in the non-secure memory portion of the non-volatile SMD without incurring the performance degradation that would be caused by storing the data in the secure memory portion of the SMD. Storing the tokens in the secure memory portion has a much smaller effect on performance than storing the data itself in the secure memory portion because the tokens are significantly smaller than the data, and thus can be processed (e.g., encrypted) and stored in the secure memory portion in less time than the data. The disclosed techniques provide secure modification detection using authenticity and replay protection features of the SMD without the performance penalty of storing the data in the secure memory portion of the SMD. Thus, the security features provided by the SMD are extended to the non-secure memory portion in which the data is stored. Another technical advantage is that the disclosed techniques rewrite less data to the SMD when a data block is updated. Since the authentication token applies to a data block, there is no need to recompute the authentication token for the data stored in other data blocks when data in one of the data blocks changes. As such, data blocks and authentication tokens that are not affected by a data write or update operation need not be re-written, thereby reducing wear and extending the lifetime of the SMD. These technical advantages represent one or more technological improvements over prior art approaches.

### BRIEF DESCRIPTION OF THE DRAWINGS

The present systems and methods for securely detecting changes in data in autonomous or semi-autonomous systems and applications are described in detail below with reference to the attached drawing figures, wherein:

FIG. 1 illustrates a computing device configured to implement one or more aspects of various embodiments.

FIG. 2 is a more detailed illustration of the security manager and contents of the secure memory device of FIG. 1, according to various embodiments;

FIG. 3 illustrates a flow diagram of a method for securely detecting changes in data, according to various embodiments;

FIG. 4 illustrates a flow diagram of a method for securely accessing data stored in a non-secure memory, according to various embodiments;

FIG. 5A is an illustration of an example autonomous vehicle, in accordance with some embodiments of the present disclosure;

FIG. 5B is an example of camera locations and fields of view for the example autonomous vehicle of FIG. 5A, in accordance with some embodiments of the present disclosure;

FIG. 5C is a block diagram of an example system architecture for the example autonomous vehicle of FIG. 5A, in accordance with some embodiments of the present disclosure;

FIG. 5D is a system diagram for communication between cloud-based server(s) and the example autonomous vehicle of FIG. 5A, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

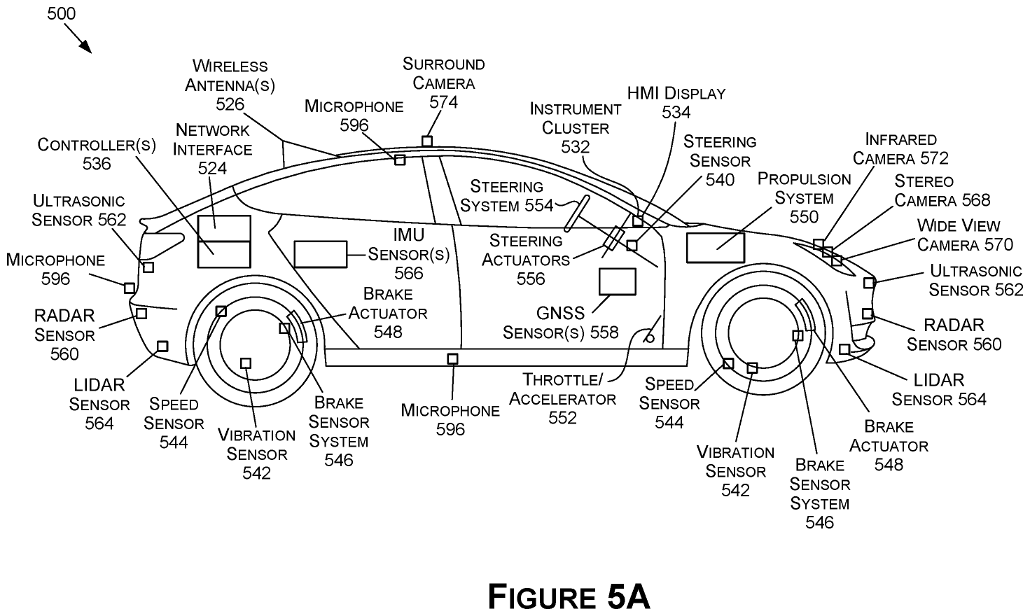

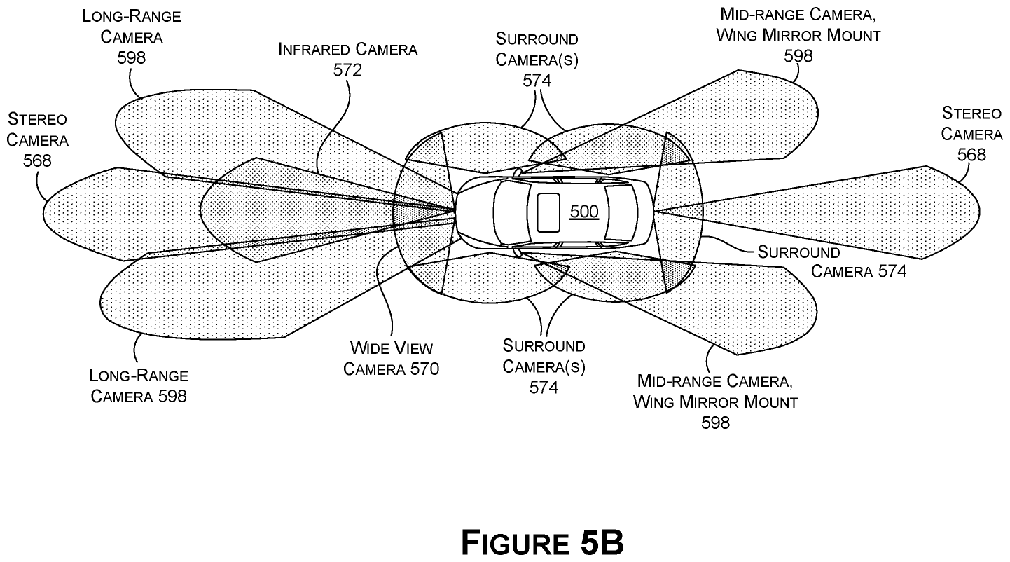

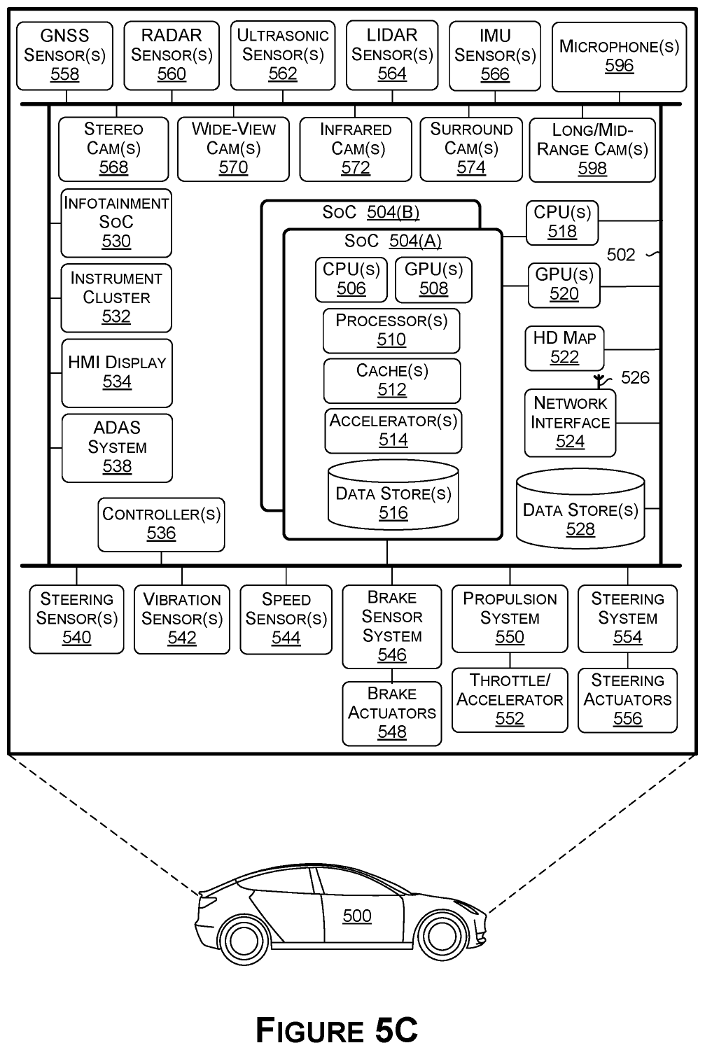

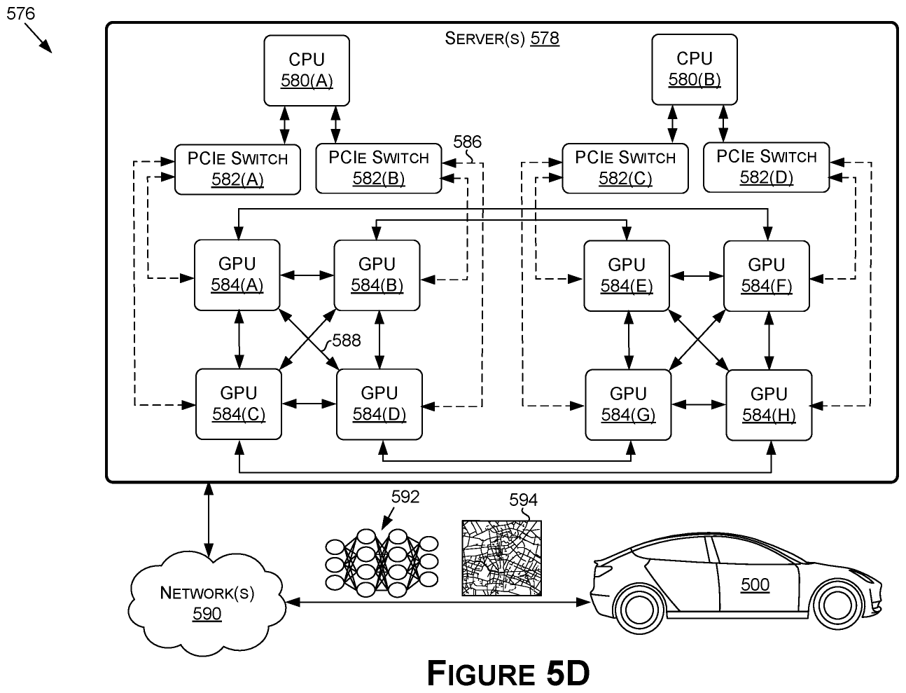

Systems and methods are disclosed for securely detecting changes in data. Although the present disclosure may be described with respect to an example autonomous or semi-autonomous vehicle or machine 500 (alternatively referred to herein as “vehicle 500” or “ego-machine 500,” an example of which is described with respect to FIGS. 5A-5D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to monitoring sensor performance in autonomous and/or semi-autonomous vehicles, this is not intended to be limiting, and the systems and methods described herein may be used in augmented reality, virtual reality, mixed reality, robotics, security and surveillance, autonomous or semi-autonomous machine applications, and/or any other technology spaces where sensor monitoring may be used.

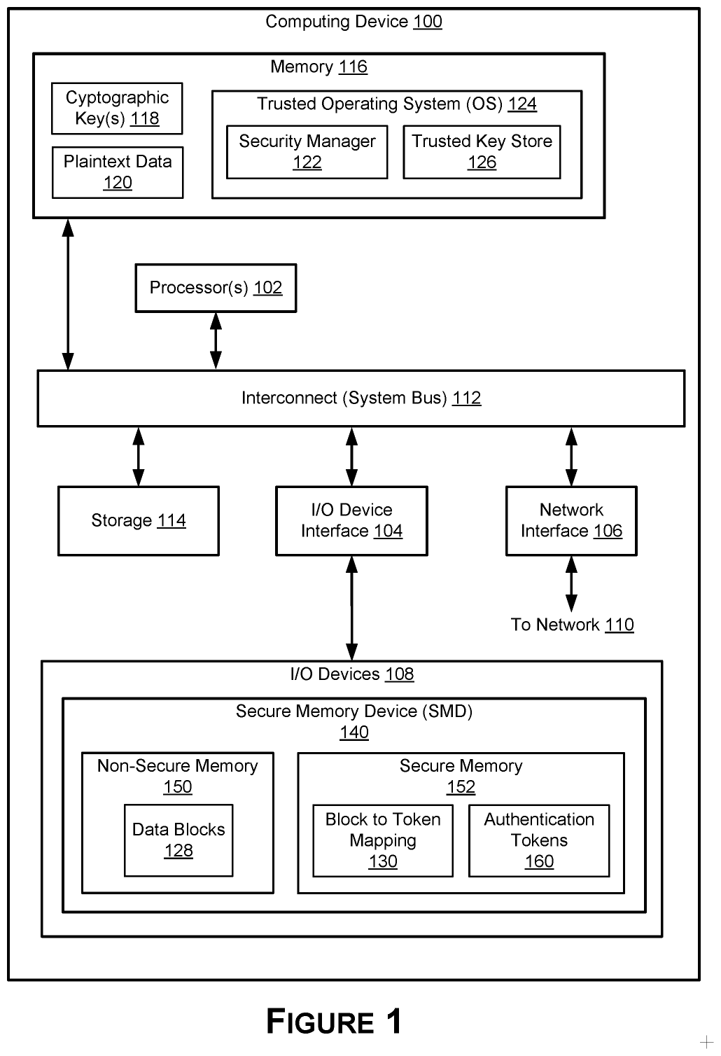

FIG. 1 illustrates a computing device 100 configured to implement one or more aspects of various embodiments. In at least one embodiment, computing device 100 includes a desktop computer, a laptop computer, a smart phone, a personal digital assistant (PDA), a tablet computer, a server, one or more virtual machines, an embedded system, an embedded hardware module that includes a system on a chip, a system on a chip, a computing system of an autonomous, semi-autonomous, or a non-autonomous machine, and/or any other type of computing device configured to receive input, process data, and optionally display images, and is suitable for practicing one or more embodiments. The computing device 100 includes a memory 116, one or more processors 102, an interconnect 112, storage 114, an Input/Output (I/O) device interface 104, and a network interface 106. The computing device 100 also includes and/or communicates with one or more I/O device(s) 108. The I/O devices 108 include a secure memory device (“SMD”) 140. The I/O device(s) 108 communicate with the interconnect 112 via the I/O device interface 104. The processor(s) 102 communicate with the SMD 140 via the interconnect 112 and/or the I/O device interface 104. The memory 116 can be a volatile random-access memory or other suitable type of memory. The I/O device interface 104 can include a Serial Peripheral Interconnect (SPI) bus interface, and the processor(s) 102 can communicate with the SMD 140 via an SPI protocol using the interconnect 112, for example.

The computing device 100 executes a trusted operating system (OS) 124, which resides in the memory 116. The trusted OS 124 includes a security manager 122 and a trusted key store 126. The security manager 122 stores data in and retrieves data from the SMD 140 in response to storage access requests from applications executing on computing device 100. For example, the security manager 122 stores cryptographic keys 118 in the SMD 140 and retrieves cryptographic keys 118 from the SMD 140 in response to requests from the trusted key store 126 or other applications (not shown) executing on computing device 100. The term “cryptographic key” (“key”) herein refers to data that represents the key 118, such as a sequence of bytes and a length of the sequence. The trusted key store 126 can be an application that maintains a set of cryptographic keys 118 for use by other applications. The data that represents the key 118 can also include attributes of the key 118, such as a key size, expiration time or date, access permissions, and so on. The security manager 122 and trusted key store 126 can be applications that execute in a Trusted Execution Environment (TEE) using the trusted OS 124, for example.

The SMD 140 includes non-volatile memory that retains data when powered off, such as flash memory. The SMD 140 includes a non-secure memory 150 and a secure memory 152. The non-secure memory 150 can be a non-secure region of the non-volatile memory of the SMD 140. That is, data stored in the non-secure memory 150, such as a set of data blocks 128, is retained when the SMD 140 is powered off, but is not encrypted or otherwise protected by the SMD 140 from unauthorized access. An individual data block in the set of data blocks 128 is also referred to herein as a “data block” 128 for brevity.

The secure memory 152 of the SMD 140 stores data that is encrypted, e.g., by a processor or cryptographic component of the SMD 140, using an SMD key prior to being stored in flash memory. The encrypted data stored in the secure memory 152 can be retrieved and decrypted, e.g., by the processor or cryptographic component using the SMD key. The SMD key can be a symmetric key stored in the SMD 140. In some embodiments, encryption and/or decryption of the data stored in the secure memory 152 is performed by a processor outside the SMD 140, e.g., by the processor(s) 102 using a copy of the SMD key that is stored in the computing device 100. Using the SMD key, the trusted OS 124 executing on the processor(s) 102 can encrypt plaintext data 120 prior to sending the plaintext data 120 to the secure memory 152, and can decrypt ciphertext data retrieved from the secure memory 152. The SMD key can be based on fuses of the computing device 100 that have been configured by provisioning operations during a manufacturing process, for example. In addition to storing data in the secure memory 152 in encrypted format, the SMD 140 provides tamper-resistant features that prevent access to the contents of the secure memory 152. The tamper-resistant features can prevent physical access that involves physically tampering with the SMD 140, for example. The SMD 140 also provides authenticity and replay protection features that provide secure detection of modifications to data stored in the secure memory 152 of the SMD 140.

Since the trusted key store 126 maintains the set of one or more keys 118 in the memory 116, there is a possibility that the keys 118 will be lost or erased from the memory 116, e.g., if power to the computing device 100 is lost. Each key 118 can include key data, such as a representation of the key 118, and the size of the key data. The trusted key store 126 uses the security manager 122 to store copies of the key(s) 118 in the SMD 140, so that copies of the key(s) 118 are retained at the computing device 100 if the computing device 100 is powered off or the memory 116 is otherwise erased or overwritten.

The security manager 122 performs operations involved in securely storing the key(s) 118 and/or other data, such as plaintext data 120, in data blocks 128 in the non-secure memory 150 of the SMD 140. The security manager 122 checks for changes in the contents of the data blocks 128 using authentication tokens 160 that are stored in the secure memory 152 of the SMD 140. Each authentication token (“token”) 160 is a value that can be subsequently used to determine whether the contents of a respective data block 128 have changed. For example, each token 160 can be a cryptographic message authentication code (“MAC”) based on the data block 128, a cryptographic hash code based on the data block 128, or other value that can subsequently be used to determine whether the data block 128 has changed. If a data block is subsequently determined to have changed, then the data stored in the data block 128, such as a copy of a key 118, has been changed. If the change is not expected, then tampering may be detected (e.g., inferred to have occurred).

In response to a request from an entity such as the trusted OS 124, the trusted key store 126, or other application to store data in the SMD 140, the security manager 122 stores the data in one or more data blocks 128 of the non-secure memory 150 and generates one or more respective tokens 160 based on the one or more respective data blocks 128. The data can be, for example, key(s) 118, plaintext data 120, or other data for which detection of changes to the non-volatile memory in the SMD 140 is desired. The security manager 122 stores the tokens 160 in the secure memory 152 and also stores an association between each data block 128 and the respective token 160 in a block to token mapping 130.

Subsequently, in response to a request from an entity such as the trusted OS 124, the trusted key store 126, or other application to read from a data block 128, security manager 122 verifies that the contents of the data block 128 have not been modified since the token 160 for the data block 128 was generated. For example, the security manager 122 can perform the verification by authenticating the data block 128 using the respective token 160. To authenticate the data block 128, the security manager 122 generates a current token based on the current contents of the data block 128 using the same algorithm or operation that was used to generate the token 160. The security manager 122 compares the current token to the token 160. If the current token matches the token 160, then the authentication is successful, and the security manager 122 determines that the contents of the data block 128 have not changed since the token 160 was generated. If the current token does not match the token 160, then the security manager 122 determines that the contents of the data block 128 have changed.

The security manager 122 can perform the verification prior to providing the contents of the data block 128 to the requesting entity. If the contents of the data block 128 have changed, then the security manager 122 causes the read request to fail with an error. In this way, the security manager 122 prevents unexpectedly modified data, such as stored copies of key(s) 118, from being used by the trusted OS 124 or other applications such as the trusted key store 126.

It is noted that the computing device described herein is illustrative and that any other technically feasible configurations fall within the scope of the present disclosure. For example, multiple instances of trusted OS 124 and/or security manager 122 may execute on a set of nodes in a distributed and/or cloud computing system to implement the functionality of computing device 100. Alternatively, computing device 100 may be implemented similar to that of the computing device of the example autonomous or semi-autonomous machine 500 described at least with respect to FIGS. 5A-5D.

In at least one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and/or a network interface 106. Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing device 100 may correspond to a physical computing system (e.g., a system in a data center or a machine) and/or may correspond to a virtual computing instance executing within a computing cloud.

In at least one embodiment, I/O devices 108 include devices capable of receiving input, such as a keyboard, a mouse, a touchpad, a VR/MR/AR headset, a gesture recognition system, a steering wheel, mechanical, digital, or touch sensitive buttons or input components, and/or a microphone, as well as devices capable of providing output, such as a display device, haptic device, and/or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In at least one embodiment, network 110 is any technically feasible type of communications network that allows data to be exchanged between computing device 100 and internal, local, remote, or external entities or devices, such as a web server or another networked computing device. For example, network 110 may include a wide area network (WAN), a local area network (LAN), a wireless (e.g., WiFi) network, and/or the Internet, among others.

In at least one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Processing engine 122 and/or analysis engine 124 may be stored in storage 114 and loaded into memory 116 when executed.

In one embodiment, memory 116 includes a random-access memory (RAM) module, a flash memory unit, and/or any other type of memory unit or combination thereof. Processor(s) 102, I/O device interface 104, and network interface 106 may be configured to read data from and write data to memory 116. Memory 116 may include various software programs or more generally software code that can be executed by processor(s) 102 and application data associated with said software programs, including processing engine 122 and/or analysis engine 124. Processor(s) 102 may be configured to read data from and write data to non-secure memory 150 and secure memory 152 of SMD 140 by communicating with SMD 140 via interconnect 112 and I/O device interface 104.

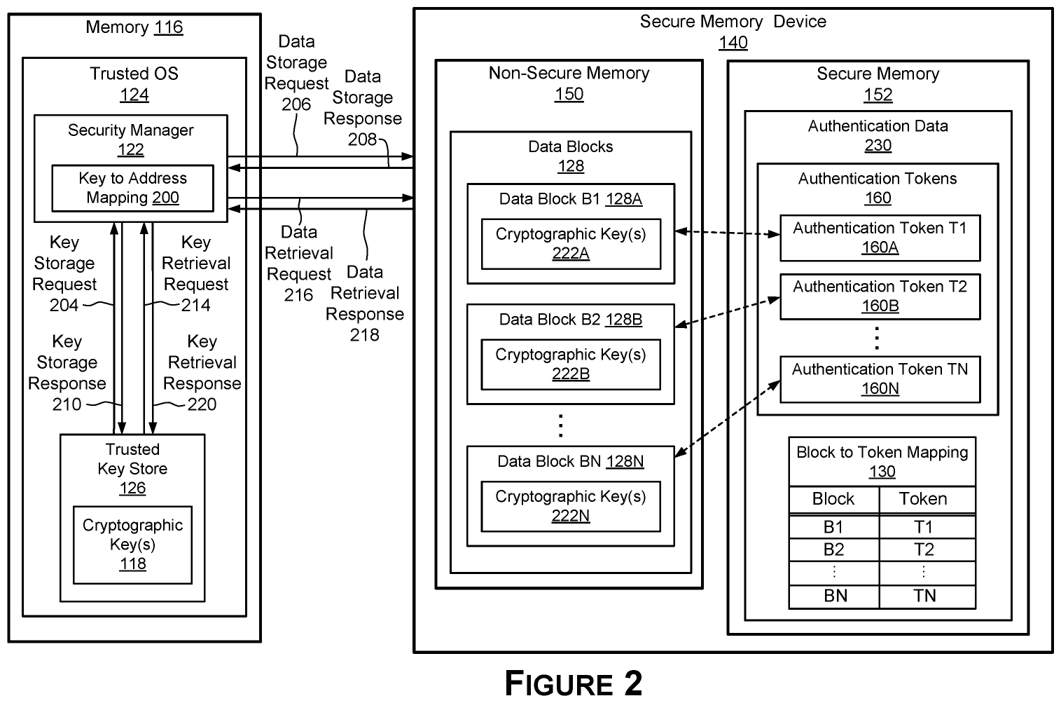

FIG. 2 is a more detailed illustration of the security manager 122 and contents of the secure memory device (SMD) 140 of FIG. 1, according to various embodiments. As shown, the trusted OS 124, which includes the security manager 122 and the trusted key store 126, resides in the memory 116. The data blocks 128 are stored in the non-secure memory 150. There are N data blocks, of which three are shown, labeled data block B1 128A, data block B2 128B, and data block BN 128N. The trusted key store 126 generates or receives keys 222 and stores the keys 222 in the secure volatile memory 152 in the form of data blocks 128. One or more keys 222 are stored in each data block 128. Each of the data blocks 128 can be of the same size, and the size is referred to as a “block size”. The block size can be, for example, 4096 bytes or other suitable size, e.g., 1024 bytes, 2096 bytes, 8192 bytes, or the like. In one example, the block size can correspond to the sector size (e.g., smallest writable block size) of the SMD 140, e.g., 4096 bytes. The block size can be below a threshold block size, e.g., 16 k bytes, 32 k bytes, or other determined threshold size, that corresponds to a size beyond which performance of the SMD 140 can degrade.

The contents of each data block 128 can include application-specific information, such as one or more keys 222 in an automotive application. Thus, although the keys 222 are shown as the content of data blocks 128, any suitable data can be stored in the data blocks 128 in other examples and embodiments. In the example of FIG. 2, key(s) 222A are stored in the data block B1 128A, key(s) 222B are stored in the data block B2 128B, and so on, through key(s) 222N, which are stored in the data block BN 128N.

The security manager 122 generates a set of authentication tokens (“tokens”) 160 for the respective data blocks 128, and stores the tokens 160 in the SMD 140. For example, each token 160 can be a hash value, such as a MAC, a cryptographic hash value generated by the SHA-1 (Secure Hash Algorithm 1) or the like, or other value that changes if any portion of the contents of the data block 128 changes. The MAC is also referred to herein as a “MAC value”. The MAC can be generated by encrypting the message authentication code of the data block 128 using an encryption algorithm with a cryptographic key (“MAC key”). The MAC key is also referred to herein as a “message authentication key” or “MAC encryption key”. The MAC can be used to verify that a data block has not changed by generating a current MAC based on the data block with the MAC key and comparing the current MAC to a previous MAC that was previously generated using the MAC key based on the data block. Thus, the data block and the MAC key are inputs to the MAC generation operation, which produces a MAC. More specifically, a MAC value, a MAC key, and another cryptographic hash value are inputs to the MAC verification operation, which produces a result indicating whether the encrypted cryptographic hash value matches the other cryptographic hash value. Thus, the MAC operation generates a hash value based on the data block 128 and encrypts the hash value using the MAC key to form a MAC value. In some embodiments, each token 160 can be a MAC value, which includes a cryptographic hash (of a data block 128) that has been encrypted using a specified MAC key. In other embodiments, the MAC value itself can optionally be encrypted using another cryptographic key. In such other embodiments, each token 160 can be an encrypted MAC value, which includes a cryptographic hash (of a data block 128) that has been encrypted multiple times, e.g., using a MAC operation with a specified MAC key to generate the MAC value, and using a subsequent encryption operation with another specified cryptographic key to encrypt the MAC value. The cryptographic key used to generate and verify the MAC can be stored securely using the embedded hardware module 138, e.g., in the secure volatile memory 152 and/or the SMD 140. The cryptographic key for generating and verifying the MAC can be based at least in part on the SMD key associated with the SMD 140, which is described herein with respect to FIG. 1. Alternatively or additionally, the security manager 122 can generate the cryptographic key for encrypting and decrypting the MAC using a suitable key generation algorithm for any suitable encryption algorithm. Each MAC can be, for example, up to 16 bytes in length (e.g., if the encryption algorithm is an Advanced Encryption Standard (AES) algorithm), or up to 8 bytes in length (e.g., if the encryption algorithm is Triple Data Encryption Standard (DES)), In various embodiments, a token 160 is stored in the SMD 140 for each data block 128. Since there are N data blocks 128 in the example of FIG. 2, N tokens 160 are stored in SMD 140, including token T1 160A and token T2 160B through token TN 160N.

The security manager 122 generates a block to token mapping 130 that associates each data block 128 with the respective token 160 that is stored in the SMD 140, so that the token 160 for a given data block 128 can be subsequently identified. The block to token mapping 130 can be a table in which each record associates a data block 128 with a token 160, for example. The block to token mapping 130 can associate a memory address of each data block 128 in the non-secure memory 150 with a corresponding memory address at which the respective token 160 is stored in the secure memory 152. Although the block to token mapping 130 is described as being stored in the secure memory 152 in the examples herein, the block to token mapping 130 can be stored in the non-secure memory 150 or both the non-secure memory 150 and the secure memory 152 in other examples and embodiments. Further, although the block to token mapping 130 is described as a table of records in examples herein, the block to token mapping 130 can be represented using any suitable data structure in other examples and embodiments.

The block to token mapping 130 can include a record for each data block 128. As shown in the example of FIG. 2, a record associates the data block B1 128A with the token T1 160A, another record associates the data block B2 128B with the token T2 160B, and an Nth record associates the data block BN 128N with the token TN 160N.

When a memory access operation, such as a read operation, is requested for data in a given data block 128, the security manager 122 uses the token 160 associated with the given data block 128 to determine whether the given data block 128 has been modified since the token 160 was generated. The security manager 122 identifies the token 160 associated with the given data block 128 by querying the block to token mapping 130, and retrieves the identified token 160 from the SMD 140. The security manager 122 then computes an updated token based on the data in the given data block 128 and compares the updated token to the identified token 160 retrieved from the SMD 140. If the updated token matches (e.g., is equal to) the identified token 160, then the security manager 140 determines that the given data block 128 has not been modified since the identified token 160 was generated, and returns the data in the given data block 128 as a result of the read operation. Otherwise, the updated token does not match (e.g., is not equal to) the identified token 160, and the security manager generates a result indicating that the data integrity check has failed. An application, such as an automotive system, that uses the security manager 122 can then perform appropriate actions based on the result of the read operation. If the result indicates that the data integrity check passed, the application can use the returned data. Otherwise, the application can discard encrypted sensor results associated with each key stored in the given data block.

The security manager 122 can optionally authenticate a data block 128 prior to a write operation if a token exists in the block to token mapping 130 for the data block 128. If the size of the data being written to the data block 128 is smaller than the sector size (e.g., the smallest writable flash memory block size) of the SMD 140, then the SMD 140 can copy the portion of the data block 128 that is not being modified by the write operation to another flash memory block without changing the contents of that portion of the data block 128. That portion of the data block 128 can be authenticated to check for unexpected modification. To detect such unexpected modification, the security manager 122 can authenticate the data block 128 prior to a write operation for which the data being written is smaller than the smallest writable block size of the SMD 140. Further, even if the data being written is the same size as the smallest writable block size of the SMD 140, authenticating a data block 128 in response to a write operation request but prior to overwriting the data in the data block 128 can provide an additional opportunity for the security manager 122 to detect unauthorized modification of data blocks 128. Accordingly, in some embodiments, if the requested memory access operation is a write of given data to a given data block 128, and the security manager 122 determines, using the token 160 associated with the data block 128, that the given data block 128 has not been modified, then the security manager 122 performs the write operation on the given data block 128. The security manager 122 then generates an updated token 160 based on the contents of the updated data block 128 and stores the updated token 160 in the secure memory 152. In some embodiments, the authentication and write operations performed in response to the write operation request can be performed in an atomic operation to avoid inconsistencies that could be introduced by other intervening operations on the SMD 140 or block to token mapping 130.

Example interactions between the trusted key store 126 and security manager 122 and between the security manager 122 and the SMD 140 in various embodiments will now be described. To cause a key 118 to be stored in the SMD 140, e.g., in response to a request from an application to generate or access a key, the trusted key store 126 sends a key storage request 204 to the security manager 122. The key storage request includes the key 118 to be stored and a key identifier of the key to be stored. Alternatively or additionally, the key storage request can specify a memory address of the key 118 or other suitable information identifying the key 118 to be stored.

Upon receiving the key storage request 204, the security manager 122 generates and sends a data storage request 206 that includes the key 118 and the size of the key 118 to the SMD 140. The data storage request 206 also includes a memory address in non-secure memory 150 at which to store the key 118. The data storage request 206 can be a memory write request, for example. The memory address identifies a location in the non-secure memory 150 at which to store the key 118. The security manager 122 can determine the memory address using a suitable memory allocation technique, for example.

In response to receiving the data storage request 206 from the security manager 122, the SMD 140 stores the data received in the data storage request 206 in the non-secure memory 150 at the memory address specified in the data storage request 206. In the example of FIG. 2, the data sent from the security manager 122 includes a key 118. Storing the key 118 in the non-secure memory 150 results in a key 222 stored in the non-secure memory 150. That is, the key 118 received in the data storage request 206 is stored in at least one data block 128A as the key 222. Because the non-secure memory 150 is divided into data blocks 128, the memory address is in one of the data blocks 128, such as data block B1 128A.

Depending on the size of the key 222, the key 222 can be smaller than the data block 128A, the same size as the data block 128A, or larger than the data block 128A. If the key 222 is smaller than the data block 128A, then other data, such as another key 222, can be stored in the data block 128A, e.g., in response to other data storage requests. If the key 222 is larger than the data block 128A, then the key 222 can be stored in the data block 128A and in one or more other data blocks 128B that follow the data block 128A consecutively in the non-secure memory 150 of the SMD 140. Although the data stored in the data block(s) 128 represents a key 118 in examples and embodiments described herein, the data can represent other data in other examples and embodiments. Further, although the data specified in the data storage request 206 includes key(s) 118 in the examples and embodiments described herein, the data specified in the data storage request 206 can include other data in other examples and embodiments.

The security manager 122 creates or updates authentication data 230 in response to receiving the key storage request 204. The authentication data 230 is for subsequent use in determining whether a data block 128 has changed since being stored. The authentication data 230 is stored in the secure memory 152 and includes a set of one or more tokens 160 and a block to token mapping 130. The security manager 122 stores a token 160 in the set of tokens 160 and adds an association between the data block 128 and the token 160 to the block to token mapping 130. The block to token mapping 130 includes, for each data block 128 that is stored in the SMD 140, a block to token association that associates the data block 128 with a token 160 that can be used to determine whether the contents of the data block 128 have changed since the token 160 was computed. The block to token mapping 130 can be represented as a table data structure such as a lookup table, hash table, or the like, in which each block to token association in the block to token mapping 130 is represented as a record or row, for example. The data block 128 portion of each block to token association can be stored in a “block” column of a table data structure that represents the block to token mapping 130. The token 160 portion of each block to token association can be stored in a “token” column of the table data structure. In another example, the token 160 portion can be stored in the secure memory 152 at a suitable memory address, and the memory address of the token 160 can be stored in the token column of the table data structure.

The security manager 122 stores the token 160, e.g., a token 160A, in a set of tokens 160 in the secure memory 152. The token 160A can subsequently be compared to a subsequently calculated token to detect modification of the associated data block 128A, as described herein. The security manager 122 also stores an association between a memory address of the data block 128 and a memory address of the token 160 in the block to token mapping 130. For example, if data such as a cryptographic key 222B is stored in a data block B2 128B in response to a data storage request 206, then the security manager 122 generates a token 160B based on the data block B2 128B. The security manager 122 stores the token T2 160B in the set of tokens 160, and stores an association between the address of data bock B2 128B and the token T2 in the block to token mapping 130.

The block to token association stored in the block to token mapping 130 can subsequently be used to identify the token 160 to use for authentication of a given data block 128. Although the token 160 is used to authenticate (e.g., detect changes in) cryptographic keys 222 in examples described herein, the token 160 can be used to authenticate any data stored in the data blocks 128 in other examples. Further, although the token 160 is described as being a cryptographic hash code, the token 160 can be generated using any suitable operation that produces a different value for each different input. If a key 222 is larger than the data block size, then the security manager 122 stores the key 222 in multiple data blocks 128. The security manager 122 generates the authentication data 230, including a token 160 and block to token association in the block to token mapping 130, for each data block 128. A key 222 larger than one data block 128 can be authenticated by authenticating each data block 128 that contains a portion of the key 222.

Subsequent to storing the data block(s) 128 in the non-secure memory 150 and storing the authentication data 230 in the secure memory 152, the SMD 140 sends a data storage response 208 to the security manager 122. Upon receiving the data storage response 208, the security manager 122 can update a key to address mapping 200 to include an association between a key identifier of the key 118 and the address of the key 222 in the non-volatile, non-secure memory 150 at which a copy of the key 118 is stored. The key to address mapping 200 can be represented as a table data structure such as a lookup table, hash table, or the like, containing a set of key to address associations. Each key to address association can be represented as a record or row of the table, for example. The security manager 122 can store the memory address of the key 222 and the key identifier of the key 222 in a key to address association in the key to address mapping 200. The security manager 122 can use the key to address association to subsequently determine the memory address of the key 222 in response to a request to retrieve the key 222. Thus, the key to address mapping 200 includes, for each key 222 that is stored in the SMD 140, an association between a key identifier of the key 222 and the memory address in the SMD 140 at which each key 222 is stored. The key to address mapping 200 can include additional information, such as the size of the key 222.

As an example, upon storing a key 222 in the SMD 140, the security manager 122 can create a key to address association containing the key identifier of the key 222, the size of the key 222, and the memory address at which the key 222 is stored. The security manager 122 can store the key to address association in the key to address mapping 200. The security manager 122 can store the key to address mapping 200 in the memory 116, the non-secure memory 150, and/or in the secure memory 152. The security manager 122 then sends a key storage response 210 to the trusted key store 126 indicating that the key has been successfully stored.

The security manager 122 can also receive key retrieval requests 214 from the trusted key store 126 and/or other applications to retrieve or otherwise access keys 222 that have been previously stored by the security manager 122. Each key retrieval request 214 specifies a key identifier of a key 222 to be retrieved. The security manager 122 retrieves the requested key 222 from the SMD 140 and performs appropriate actions, such as sending the key 222 to the requesting trusted key store 126 or application in a key retrieval response 220 or performing a cryptographic operation using the key 222.

To retrieve the requested key 222, the security manager 122 uses the key to address mapping 200 to identify the memory address and size of the requested key 222 in the non-secure memory 150. The security manager 122 can identify the memory address and size by searching the key to address mapping 200 for a key to address association that contains the key identifier specified in the key retrieval request 214. The key to address association that contains the specified key identifier indicates the memory address and size of the requested key 222. The security manager 122 then sends a data retrieval request 216 specifying the memory address and size of data to be retrieved to the SMD 140. The data retrieval request 216 can be a memory read request, for example.

In response to receiving the data retrieval request 216 from the security manager 122, the SMD 140 retrieves data having the specified memory address and specified size from the non-secure memory 150. The SMD 140 sends the retrieved data to the security manager 122 in a data retrieval response 218. Upon receiving the data retrieval request 216, the security manager 122 performs authentication operations to determine whether the retrieved data has been modified since being stored in the SMD 140. The security manager 122 identifies the data block 128 that contains the specified memory address, e.g., using an operation provided by the trusted OS 124 and/or by the SMD 140. The security manager 122 can then retrieve the token associated with the identified data block 128 from the memory address in the secure memory 152 associated with the identified data block 128 by the block to token mapping 130. For example, if the data retrieval request 216 specifies a cryptographic key 222B contained in the data block B2 128B, then the security manager 122 queries the block to token mapping 130 for a record (e.g., row) that associates the data block B2 128B with a token. In the example of FIG. 2, the block to token mapping 130 includes an association between data block B2 128B and the memory address of the token T2 160B. Accordingly, the security manager 122 uses the memory address of the token T2 160B specified in the block to token mapping 130 to retrieve the token T2 160B. The security manager 122 can then use the retrieved token to authenticate the identified data block 128. For example, if the key 222 fits within a single data block 128, the security manager 122 can authenticate the identified data block 128 by generating a current token based on the current contents of the identified data block 128 and comparing the current token to the retrieved token. If the current token does not match the retrieved token, then the security manager 122 determines that the block authentication has failed, and the contents of the identified data block 128 have changed. Since the identified data block 128 contains the requested key 222, the security manager 122 determines that the requested key 222 has changed, and performs an appropriate action. For example, the security manager 122 can provide an error indication instead of the requested key 222 to the trusted key store 126 or other application that requested the key 222. Otherwise, the retrieved token matches the current token, in which case the security manager 122 determines that the authentication has succeeded, and thus the data block 128 that contains the requested key 222 has not changed since the retrieved token was generated.

In examples in which the key 222 does not fit within a single data block 126, the security manager 122 can determine that the key 222 is stored in multiple data blocks 128 and authenticate each data block 128 in which a portion of the key 222 is stored using the respective token 160 associated with respective data block 128. The security manager 122 can determine whether the key 222 is stored in multiple data blocks 128 by, for example, identifying the memory address in which the key 222 ends by adding the specified size received in the data retrieval request 216 to the specified memory address. The security manager 122 then determines which of the data blocks 128 contains the memory address in which the key 222 ends. If the data block 128 in which the key 222 ends is different from the data block 128 that contains the specified memory address of the key 222, then the key 222 is stored in multiple data blocks 128, and the security manager 122 authenticates each data block 128 starting at the data block 128 that contains the specified memory address of the key 222 and ending at the data block 128 in which the key 222 ends. To authenticate the multiple data blocks 128, the security manager 122 identifies the respective token 160 for each respective data block and authenticates the respective data block 128 using the respective token 160. If the authentication of any of the multiple data blocks 128 fails, e.g., the token 160 associated with one of the multiple data blocks 128 by the block to token mapping 130 does not match the current token generated for the data block 128, then the authentication of the key 222 fails. If the authentication of the key 222 fails, the security manager 122 determines that the key 222 has been modified and performs an appropriate action, such as returning an error message in a key retrieval response 220 instead of the requested key 222. Otherwise, if the authentication of each of the multiple data blocks 128 is successful, then the security manager 122 determines that the key 222 has not been modified. If the security manager 122 determines that the key 222 has not been modified, then the security manager 122 sends the key to the trusted key store 126 or other requesting operation in a key retrieval response 220.

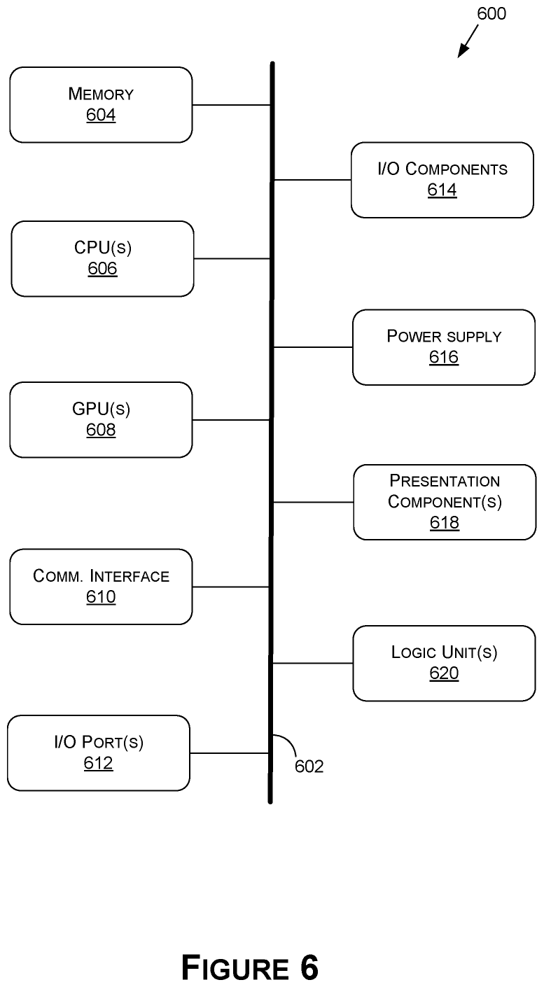

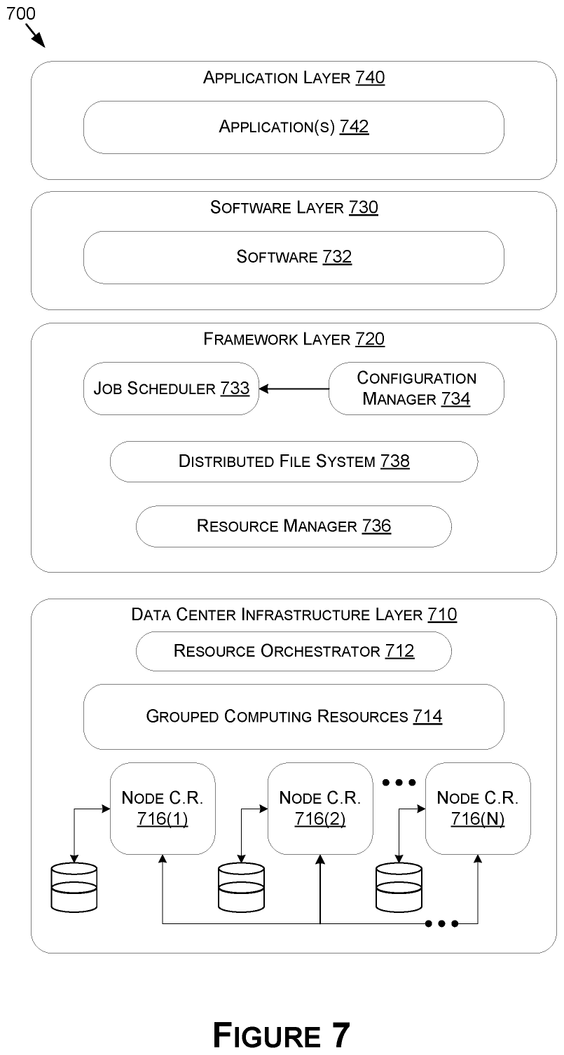

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 500 of FIGS. 5A-5D, example computing device 600 of FIG. 6, and/or example data center 700 of FIG. 7.

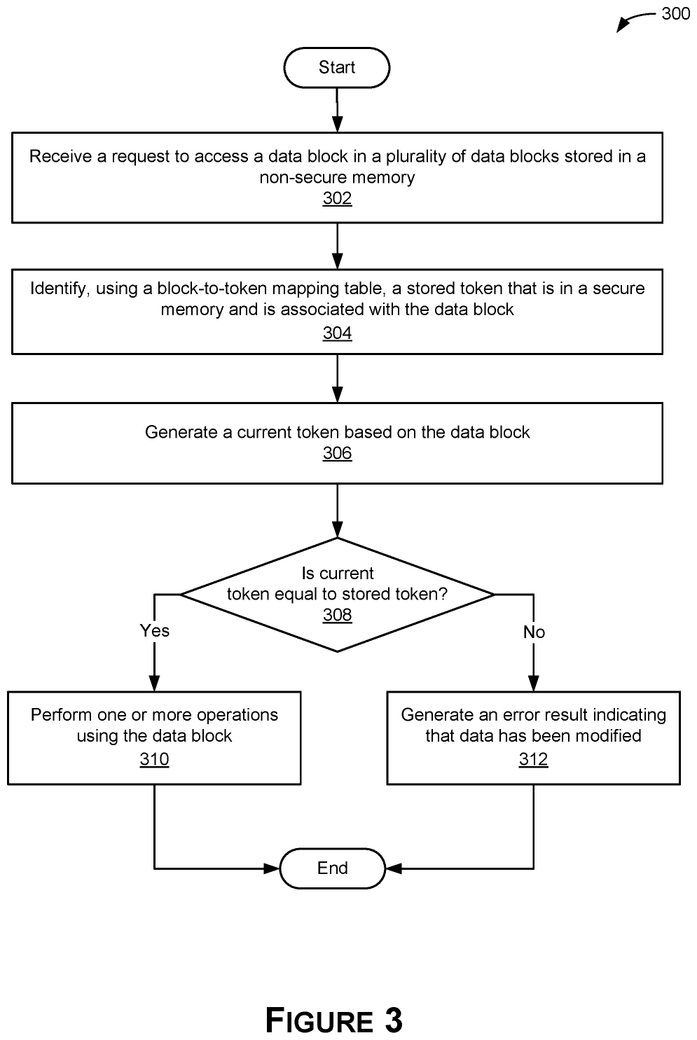

FIG. 3 illustrates a flow diagram of a method 300 for securely detecting changes in data, according to various embodiments. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIGS. 1-2. However, this method may additionally or alternatively be executed by any one system, or any combination of systems, including, but not limited to, those described herein. Further, the operations in method 300 can be omitted, repeated, and/or performed in any order without departing from the scope of the present disclosure.

As shown in FIG. 3, method 300 begins with operation 302, in which a security manager 122 receives a request to access a data block 128 stored in a non-secure memory. The request can be a request to read data from the data block 128, such as a key retrieval request 214. Alternatively, the request can be a request to write data to the data block 128, such as a key storage request 204. The request can be received from an application, such as trusted key store 126, or from a trusted OS 124, for example.

In operation 304, the security manager 122 identifies, using a block-to-token mapping 130, a stored token that is in a secure memory 140 and is associated with the data block 128. For example, the security manager 122 searches the block to token mapping 130 for a record having a block address that matches the address of the data block 128. The record specifies the memory address of the stored token 160. If such as record is not found in the block to token mapping 130, then the security manager 122 generates an error result and the method 300 ends.

In operation 306, the security manager 122 generates a current token based on the data block 128. To generate the current token, security manager 122 can compute a MAC based on the data block 128 and a MAC encryption key. For example, the MAC encryption key can be retrieved from one or more secure storage locations in the computing device 100 on which the method 300 is executing, and/or from an SMD 140 associated with the computing device 100. The MAC encryption key can be based on fuses of the computing device 100 that have been configured to match a MAC encryption key that is stored in the SMD 140 by provisioning operations during a manufacturing process, for example.

In operation 308, the security manager 122 determines whether the current token matches (e.g., is equal to) the stored token 160. If so, in operation 310, the security manager 122 performs one or more requested operations using the data block. If not, in operation 312, the security manager 122 generates an error result indicating that data has been modified.

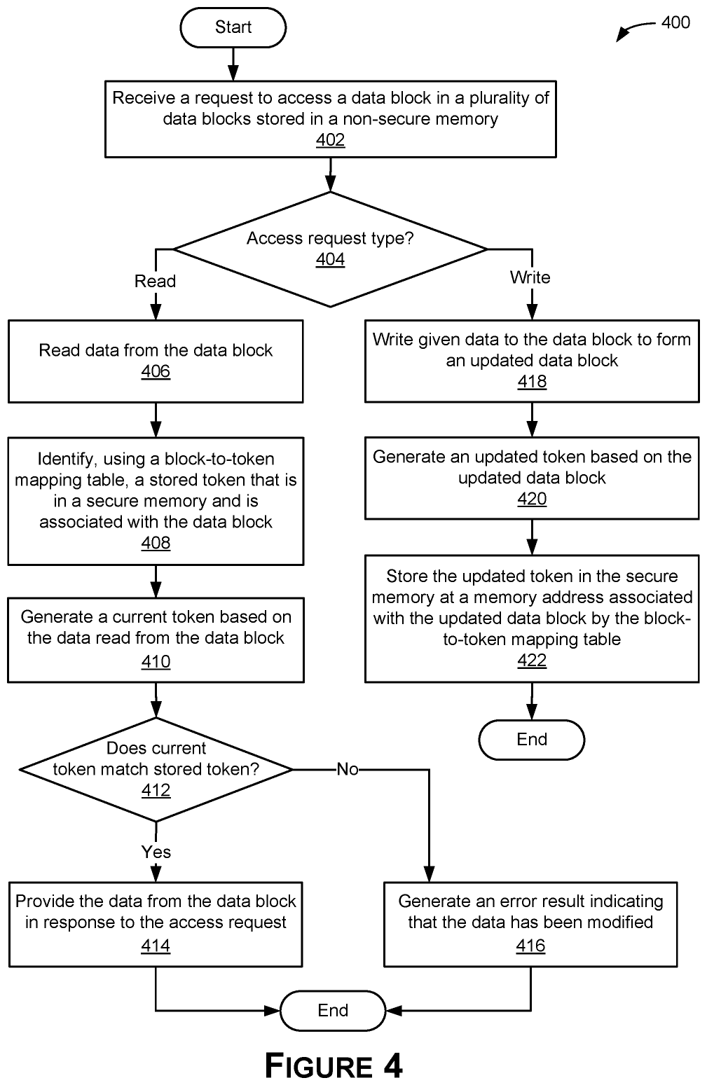

FIG. 4 illustrates a flow diagram of a method 400 for securely accessing data stored in a non-secure memory 150, according to various embodiments. Each block of method 400, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 400 is described, by way of example, with respect to the system of FIGS. 1-2. However, this method may additionally or alternatively be executed by any one system, or any combination of systems, including, but not limited to, those described herein. Further, the operations in method 400 can be omitted, repeated, and/or performed in any order without departing from the scope of the present disclosure.

As shown in FIG. 4, the method 400 begins with operation 402, in which a security manager 122 receives a request to access a data block 128 in a plurality of data blocks stored in a non-secure memory 150. The non-secure memory 150 can be in a SMD 140, for example. The access request can be a read request, e.g., a key retrieval request 214, or a write request, e.g., a key storage request 204. In operation 404, the security manager 122 determines the access request type. The access request type is either “read” (e.g., a key retrieval request 214) or “write” (e.g., a key storage request 204). If in operation 404 the security manager 122 determines that the access request type is “read”, then in operation 406, the security manager 122 reads data from the data block 128. In operation 408, the security manager 122 identifies, using a block-to-token mapping 130, a stored token 160 that is in a secure memory 162 and is associated with the data block 128. The secure memory 152 can be in the SMD 140, for example. The security manager 122 identifies the stored token by determining the memory address in the secure memory 152 associated with the identified data block 128 using the block to token mapping 130. For example, if the data retrieval request 216 specifies a cryptographic key 222B contained in the data block B2 128B, then the security manager 122 queries the block to token mapping 130 for a record (e.g., row) that associates the data block B2 128B with a token. The security manager 122 uses the memory address of the token T2 160B specified in the block to token mapping 130 to retrieve the token T2 160B.

In operation 410, the security manager 122 generates a current token based on the data read from the data block 128. In operation 412, the security manager 122 determines whether the current token matches the stored token 160. If the current token matches the stored token 160, then in operation 414, the security manager 122 performs one or more read using the data. In operation 414, the security manager 122 provides the data from the data block 128 in response to the access request. If in operation 412 the security manager 122 determines that the current token does not match the stored token 160, then in operation 416 the security manager 122 generates an error result indicating that the data has been modified.

If in operation 404 the security manager 122 determines that the access request type is “write”, then in operation 418, the security manager 122 writes given data to the data block 128 to form an updated data block 128. In this case, the received access request can be a key storage request 204, and the given data can be specified in the key storage request 204, for example. In operation 420, the security manager 122 generates an updated token 160 based on the updated data block 128. For example, in operation 420, the security manager 122 can generate a MAC based on the data block 128 and a MAC key.

In operation 422, if the block to token mapping 130 includes an association between the memory address of the updated data block 128 and a token memory address, then the security manager 122 stores the updated token 160 in the secure memory 152 at the memory address of the updated data block 128 by the block to token mapping 130. Otherwise, the block to token mapping 130 does not include an association between the memory address of the updated data block 128 and a token memory address, so in operation 422, the security manager 122 adds an association between the memory address of the updated data block 128 and the memory address of the updated token 160 to the block to token mapping 130.

In sum, the disclosed techniques detect changes in data using a security manager that receives the data, stores the data in one or more data blocks of a non-secure memory portion of a non-volatile secure memory device (SMD), generates one or more authentication tokens based on the respective data blocks, and stores the tokens in a secure memory portion of the SMD. The contents of the secure memory portion are encrypted using a cryptographic key associated with the SMD. Each token can be a hash value, such as a cryptographic message authentication code or other value determined using a cryptographic hash function based on the respective data block. The security manager also generates a block to token mapping that associates each data block with the respective token in the SMD, so that the token for a given data block can be subsequently identified. The block to token mapping can be stored in the secure memory portion of the SMD. The data in each data block can be application-specific information, such as one or more cryptographic keys in an automotive application.

When a memory read operation is requested for data in a given data block of the non-secure memory portion, the security manager uses the token associated with the given data block to determine whether the given data block has been modified since the associated token was generated. The security manager identifies the token associated with the given data block by querying the block to token mapping and retrieves the identified token from the secure memory portion of the SMD. To determine whether the data in the given data block has been modified, the security manager computes an updated token based on the current data in the given data block and compares the updated token to the identified token retrieved from the SMD. If the updated token matches the identified token, then the security manager determines that the data block has not been modified since the identified token was generated, and returns the data in the given data block as a result of the read operation. Otherwise, if the updated token is not equal to the identified token, the security manager generates a result indicating that the data integrity check has failed, and does not return the data as a result of the read operation. An application, such as an automotive system, that uses the security manager can then perform appropriate actions based on the result of the read operation. If the read operation returns data, then the application can use the returned data. For example, if the returned data contains a cryptographic key, the application can use the cryptographic key to decrypt encrypted sensor results. Otherwise, if the read operation result indicates that the data integrity check failed, the application can discard encrypted sensor results associated with the cryptographic key.

If the requested memory access operation is a write of given data to a data block in the non-secure memory portion of the SMD, the security manager stores the given data in the data block to form an updated data block. The security manager generates an updated token based on the contents of the updated data block, and stores the updated token in the secure memory portion of the SMD. The security manager can store the updated token in the secure memory portion at a memory location associated with the updated data block by the block to token mapping.

One technical advantage of the disclosed techniques relative to the prior art is the ability to detect modification of data stored in the non-secure memory portion of the non-volatile SMD without incurring the performance degradation that would be caused by storing the data in the secure memory portion of the SMD. Storing the tokens in the secure memory portion has a much smaller effect on performance than storing the data itself in the secure memory portion because the tokens are significantly smaller than the data, and thus can be processed (e.g., encrypted) and stored in the secure memory portion in less time than the data. The disclosed techniques provide secure modification detection using authenticity and replay protection features of the SMD without the performance penalty of storing the data in the secure memory portion of the SMD. Thus, the security features provided by the SMD are extended to the non-secure memory portion in which the data is stored. Another technical advantage is that the disclosed techniques rewrite less data to the SMD when a data block is updated. Since the authentication token applies to a data block, there is no need to recompute the authentication token for the data stored in other data blocks when data in one of the data blocks changes. As such, data blocks and authentication tokens that are not affected by a data write or update operation need not be re-written, thereby reducing wear and extending the lifetime of the SMD. These technical advantages represent one or more technological improvements over prior art approaches.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LiDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) (e.g., as part of the brake sensor system 546), and/or other sensor types. The controller(s) 536 may include one or more instances of processing engine 122 and/or analysis engine 124 to monitor sensor performance based on the corresponding sensor data.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the High Definition (“HD”) map 522 of FIG. 5C), location data (e.g., the vehicle's 500 location, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524 which may use one or more wireless antenna(s) 526 and/or modem(s) to communicate over one or more networks. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may be any number (including zero) of wide-view cameras 570 on the vehicle 500. In addition, any number of long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

Any number of stereo cameras 568 may also be included in a front-facing configuration. In at least one embodiment, one or more of stereo camera(s) 568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360 degree camera(s), and/or the like. Four example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C are illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500, and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 504 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LiDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 512 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high-dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LiDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex. The DLA may further utilize metrics associated with sensor performance as input into one or more neural networks.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surroundings at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 560 m (front) or 80 m (rear), and a field of view of up to 42 degrees (front) or 550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LiDAR sensor(s) 564. The LiDAR sensor(s) 564 may be used for object and pedestrian detection, emergency braking, collision avoidance, and/or other functions. The LiDAR sensor(s) 564 may be functional safety level ASIL B. In some examples, the vehicle 500 may include multiple LiDAR sensors 564 (e.g., two, four, six, etc.) that may use Ethernet (e.g., to provide data to a Gigabit Ethernet switch).

In some examples, the LiDAR sensor(s) 564 may be capable of providing a list of objects and their distances for a 360-degree field of view. Commercially available LiDAR sensor(s) 564 may have an advertised range of approximately 500 m, with an accuracy of 2 cm-3 cm, and with support for a 500 Mbps Ethernet connection, for example. In some examples, one or more non-protruding LiDAR sensors 564 may be used. In such examples, the LiDAR sensor(s) 564 may be implemented as a small device that may be embedded into the front, rear, sides, and/or corners of the vehicle 500. The LiDAR sensor(s) 564, in such examples, may provide up to a 120-degree horizontal and 35-degree vertical field-of-view, with a 200 m range even for low-reflectivity objects. Front-mounted LiDAR sensor(s) 564 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 500. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LiDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 500), while the 12V communication concept provides information about traffic further ahead. CACC systems may include either or both 12V and V2V information sources. Given the information of the vehicles ahead of the vehicle 500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network which is trained and thus reduces the risk of false positives, as described herein.

The vehicle 500 may further include the infotainment SoC 530 (e.g., an in-vehicle infotainment system (IVI)). Although illustrated and described as a SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(H) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road-work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the Al in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAS, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

In various embodiments, one or more CPU(s) 606, GPU(s) 608, and/or logic unit(s) 620 are configured to execute one or more instances of processing engine 122 and/or analysis engine 124. Statistics 210 and 212, aggregated statistics 222, posterior probabilities 224, and/or metrics 226 generated by processing engine 122 and/or analysis engine 124 can then be used to monitor the performance of various sensors and perform additional processing based on the performance of the sensors.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-716(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

1. In some embodiments, a method comprises: receiving, at a computing device, a request to access a data block of a plurality of data blocks stored in a non-secure memory; identifying, in a secure memory, a first authentication token associated with the data block; generating a second authentication token comprising a message authentication code (MAC), wherein the MAC is based on the data block and a MAC encryption key; determining whether the second authentication token corresponds to the first authentication token; and in response to determining that the second authentication token corresponds to the first authentication token, performing one or more operations using the data block.

2. The method of clause 1, wherein the data block includes a cryptographic key.

3. The method of clauses 1 or 2, wherein the first authentication token includes a MAC value.

4. The method of any of clauses 1-3, wherein the request to access the data block comprises a data retrieval request, and performing the one or more operations comprises reading data from the data block.

5. The method of any of clauses 1-4, wherein the first authentication token is identified using a block to token mapping that associates at least one data block of the plurality of data blocks with a respective authentication token stored in the secure memory.

6. The method of any of clauses 1-5, wherein the block to token mapping associates a memory address in the non-secure memory of the at least one data block with a respective memory address in the secure memory of at least one respective authentication token.

7. The method of any of clauses 1-6, wherein determining whether the second authentication token corresponds to the first authentication token comprises comparing the second authentication token to the first authentication token.

8. The method of any of clauses 1-7, wherein the second authentication token corresponds to the first authentication token when the second authentication token matches the first authentication token.

9. The method of any of clauses 1-8, wherein the request to access the data block comprises a data storage request, and wherein the one or more operations include a write operation for storing given data in the data block to form an updated data block.

10. The method of any of clauses 1-9, wherein the method further comprises: generating an updated authentication token based on an updated MAC, wherein the updated MAC is based on the updated data block and the MAC encryption key; and storing the updated authentication token in the secure memory at a memory address associated with the updated data block.

11. The method of any of clauses 1-10, wherein the memory address is associated with the updated data block by the block to token mapping.

12. The method of any of clauses 1-11, wherein performing the one or more operations comprises storing the given data in the data block.

13. The method of any of clauses 1-12, wherein at least one of the secure memory or the non-secure memory is a non-volatile memory of a secure memory device associated with the computing device.

14. The method of any of clauses 1-13, wherein the MAC encryption key is stored in one or more secure storage locations in one or more of the computing device or a secure memory device associated with the computing device.

15. In some embodiments, a processor comprises one or more processing units to perform operations comprising: receiving a request to access a data block of a plurality of data blocks stored in a non-secure memory; identifying, in a secure memory, a first authentication token associated with the data block; generating a second authentication token based on a message authentication code (MAC), wherein the MAC is based on the data block and a cryptographic key; determining whether the second authentication token corresponds to the first authentication token; and in response to determining that the second authentication token corresponds to the first authentication token, performing one or more operations using the data block.

16. The processor of clause 15, wherein the data block includes a cryptographic key.

17. The processor of clauses 15 or 16, wherein the first authentication token includes a MAC value.

18. The processor of any of clauses 15-17, wherein the processor is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality content, augmented reality content, or mixed reality content; a system implemented using a robot; a system for performing conversational AI operations; a system for generating synthetic data; a system incorporating one or more virtual machines (VMs); a system implemented at least partially in a data center; or a system implemented at least partially using cloud computing resources.

19. In some embodiments, a system comprises one or more processors to perform operations comprising: receiving, at a computing device, a request to access a data block of a plurality of data blocks stored in a non-secure memory; identifying, in a secure memory, a first authentication token associated with the data block; generating a second authentication token comprising a message authentication code (MAC), wherein the MAC is based on the data block and a MAC encryption key; determining whether the second authentication token corresponds to the first authentication token; and in response to determining that the second authentication token corresponds to the first authentication token, performing one or more operations using the data block.

20. The system of clause 19, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality content, augmented reality content, or mixed reality content; a system implemented using a robot; a system for performing conversational AI operations; a system for generating synthetic data; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method, comprising:
receiving, at a computing device, a request to access a data block of a plurality of data blocks stored in a non-secure memory;
identifying, in a secure memory, a first authentication token associated with the data block;
generating a second authentication token comprising a message authentication code (MAC), wherein the MAC is based on the data block and a MAC encryption key;
determining whether the second authentication token corresponds to the first authentication token; and
in response to determining that the second authentication token corresponds to the first authentication token, performing one or more operations using the data block.

2. The method of claim 1, wherein the data block includes a cryptographic key.

3. The method of claim 1, wherein the first authentication token includes a MAC value.

4. The method of claim 1, wherein the request to access the data block comprises a data retrieval request, and performing the one or more operations comprises reading data from the data block.

5. The method of claim 1, wherein the first authentication token is identified using a block to token mapping that associates at least one data block of the plurality of data blocks with a respective authentication token stored in the secure memory.

6. The method of claim 5, wherein the block to token mapping associates a memory address in the non-secure memory of the at least one data block with a respective memory address in the secure memory of at least one respective authentication token.

7. The method of claim 1, wherein determining whether the second authentication token corresponds to the first authentication token comprises comparing the second authentication token to the first authentication token.

8. The method of claim 1, wherein the second authentication token corresponds to the first authentication token when the second authentication token matches the first authentication token.

9. The method of claim 1, wherein the request to access the data block comprises a data storage request, and wherein the one or more operations include a write operation for storing given data in the data block to form an updated data block.

10. The method of claim 9, wherein the method further comprises:
generating an updated authentication token based on an updated MAC, wherein the updated MAC is based on the updated data block and the MAC encryption key; and
storing the updated authentication token in the secure memory at a memory address associated with the updated data block.

11. The method of claim 10, wherein the memory address is associated with the updated data block by the block to token mapping.

12. The method of claim 10, wherein performing the one or more operations comprises storing the given data in the data block.

13. The method of claim 1, wherein at least one of the secure memory or the non-secure memory is a non-volatile memory of a secure memory device associated with the computing device.

14. The method of claim 1, wherein the MAC encryption key is stored in one or more secure storage locations in one or more of the computing device or a secure memory device associated with the computing device.

15. A processor comprising:
one or more processing units to perform operations comprising:
receiving a request to access a data block in a plurality of data blocks stored in a non-secure memory;
identifying, in a secure memory, a first authentication token associated with the data block;
generating a second authentication token based on a message authentication code (MAC), wherein the MAC is based on the data block and a cryptographic key;
determining whether the second authentication token corresponds to the first authentication token; and
in response to determining that the second authentication token corresponds to the first authentication token, performing one or more operations using the data block.

16. The processor of claim 15, wherein the data block includes a cryptographic key.

17. The processor of claim 15, wherein the first authentication token includes a MAC value.

18. The processor of claim 15, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

19. A system comprising:
one or more processors to perform operations comprising:
receiving, at a computing device, a request to access a data block of a plurality of data blocks stored in a non-secure memory;
identifying, in a secure memory, a first authentication token associated with the data block;
generating a second authentication token comprising a message authentication code (MAC), wherein the MAC is based on the data block and a MAC encryption key;
determining whether the second authentication token corresponds to the first authentication token; and
in response to determining that the second authentication token corresponds to the first authentication token, performing one or more operations using the data block.

20. The system of claim 19, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of virtual reality content, augmented reality content, or mixed reality content;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
